(19) United States
(12) Patent Application Publication
(10) Pub. No.: US 2006/0083518 A1
(43) Pub. Date: Apr. 20, 2006

(54) Fiber optic connection for digital displays

(76) Inventors: Myunghee Lee, San Jose, CA (US); Ronald T. Kaneshiro, Los Altos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/966,680

(22) Filed: Oct. 14, 2004

(51) Int. Cl. H04B 10/00

(52) U.S. Cl. 398/155

(57) ABSTRACT

A digital graphics connection such as a DVI connection uses an optical fiber for transmissions representing a clock signal and parallel pixel data channels. In one embodiment, a DVI cable includes a source-side connector containing active circuitry such as a multiplexer that interleaves pixel data and clock information and a driver circuit that controls a laser transmitting an optical signal on the optical fiber. The display connector can include a photodiode, a clock and data recovery circuit, and a demultiplexer that reconstructs the parallel electronic signals.

### BACKGROUND

Most computers today manipulate digital video but include video cards or similar devices that convert the digital video to analog signals suitable for an analog display. However, digital displays such as digital flat panel monitors can directly use digital data, making digital-to-analog conversions unnecessary. To take advantage of the digital display capabilities, a number of digital graphics connection standards have been proposed that permit transmission of high bandwidth video data over a reasonable cable length. The Digital Display Working Group (DDWG), for example, introduced a standard known as DVI (Digital Visual Interface) for digital graphics connections.

FIG. 1 is a block diagram illustrating a system 100 with a conventional DVI connection 110 of video source 120 to a digital display 130. Video source 120 would typically be a computer, while digital display 130 can be a flat panel display or similar digital display. DVI connection 110 includes a multi-wire cable 112 with the appropriate connectors 116 and 118 for connections to respective connectors 126 and 138 on video source 120 and digital display 130. The DVI standard dictates shapes and pin counts of connectors 116 and 118. For ease of illustration, FIG. 1 schematically shows cable 112 as carrying just four signals RED, GREEN, BLUE, and CLOCK. Signal CLOCK in FIG. 1 represents a clock signal, and signals RED, GREEN, and BLUE represent digital bit streams respectively for red, green, and blue pixel values. However, DVI cables typically include 24 or more wires and connectors (DVI-I or DVI-D) having 24 or more pins.

Digital display 130 generally uses clock signal CLOCK for synchronization with the separate data channels providing red, green, and blue components of pixel values. DVI limits the maximum byte-rate for each channel RED, GREEN, and BLUE to about 165 MHz, which matches the “Copper Barrier” resulting from the limits that physics places on transmission of data on a copper wire. The single-link DVI connection can provide data representing up to 165 million pixels per second, which is enough to display a 1600×1200 image at a 60 Hz refresh rate. For larger displays, DVI provides for a dual-link configuration that doubles this data rate through use of three additional channels for pixel data.

Each data channel for a DVI connection conventionally uses a technique known as Transition Minimized Differential Signaling (TMDS) for data transmission. TMDS normally requires a twisted pair of copper wires for each data channel. Even with this technique, cable impedance/resistance normally limits high-bandwidth transmissions to distances less than about 10 m. Further, the cable required for a DVI connection can require a large number of copper wires. The high wire count can make a DVI cable bulky and expensive.

In view of the limitations of current digital graphics connections, systems and methods that allow low power connections over greater distances without bulky or expensive cables are sought.

### SUMMARY

In accordance with an aspect of the invention, a digital graphics connection such as a DVI connection uses an optical fiber for a high-bandwidth transmission representing a clock signal and multiple data channels. A single optical fiber can provide adequate bandwidth for all data in the single-link or the dual-link version of DVI. Bulky cables can thus be avoided and data can be transmitted over the longer distances possible for light transmission on optical fibers. To implement optical signaling, a DVI cable can include active circuitry (e.g., in the required connectors). In particular, the video source connector can include a multiplexer that interleaves electronic data and clock information and a driver circuit that controls a laser transmitting an optical signal on the optical fiber. The display connector can include a photodiode, a clock and data recovery circuit, and a demultiplexer that reconstructs the electrical signals.

One specific embodiment of the invention is a system for connecting a video source to a digital display. The system includes: a first circuit that encodes digital pixel data from parallel electronic signals into a serial optical signal; a second circuit that decodes the serial optical signal and recreates the parallel electronic signals; and an optical fiber coupled to carry the optical signal from the first circuit to the second circuit. The first circuit can be connected to or incorporated in a first DVI connector, and the second circuit can be connected to or incorporated in a second DVI connector.

The parallel electronic signals can represent multiple data channels for pixel data (e.g., red, green, and blue pixel values) and may additionally represent a clock signal. More specifically, the parallel electronic signals can include three parallel electronic data channels, where each data channel represents an independent bit stream that indicates values of a corresponding color component of the pixels. For a DVI connection, the electronic signals are TMDS signals.

The first circuit can be implemented using: a multiplexing circuit having the parallel electronic signals as input signals; a driver circuit coupled to an output of the multiplexing circuit; and a light-emitting source such as a Vertical Cavity Surface Emitting Laser (VCSEL) or Fabry-Perot (FP) laser diode that under the control of the driver circuit generates the optical signal. The second circuit can be implemented using: a photodiode matching the type of the light source coupled to receive the optical signal from the optical fiber; a quantizer connected to generate an binary signal from a signal output from the photon diode; a clock recovery circuit connected to generate a clock signal from the binary signal; and a demultiplexing circuit connected to receive the clock signal from the clock recover circuit and the binary signal from the quantizer. The demultiplexing circuit has multiple lines for output of the recreated parallel electronic signals.

Another embodiment of the invention is a DVI cable. The DVI cable includes appropriate connectors, a first circuit, a second circuit, and an optical fiber. The first circuit operates to convert a plurality of TMDS signals received through the first connector into an optical signal. The second circuit operates to recreate the TMDS signals from the optical signal and transmits the TMDS signals via the second connector. The single optical fiber conveys the optical signal from the first circuit to the second circuit. The TMDS signals can represent a clock signal and parallel channels for pixel data.

Yet another embodiment of the invention is a method for transmitting digital data to a digital display. The method receives multiple parallel electronic signals through a first connector of a cable, where the parallel electronic signals digitally represent respective color components of pixels. Using a first circuit integrated into the cable, the parallel electronic signals are converted into a bit stream that is transmitted over an optical fiber as an optical signal representing the bit stream. A second circuit recreates the parallel electronic signals from the optical signal and transmits the recreated parallel electronic signals through a second connector of the cable.

### BRIEF DESCRIPTION OF THE DRAWINGS

FIG. 1 shows a block diagram of a system with a conventional DVI connection.

FIG. 2 shows a block diagram of a system with a DVI connection with an optical link in accordance with an embodiment of the invention.

FIGS. 3A and 3B respectively show pin patterns for conventional DVI-I and DVI-D connectors.

FIG. 4 illustrates a DVI cable with active circuitry in accordance with an embodiment of the invention.

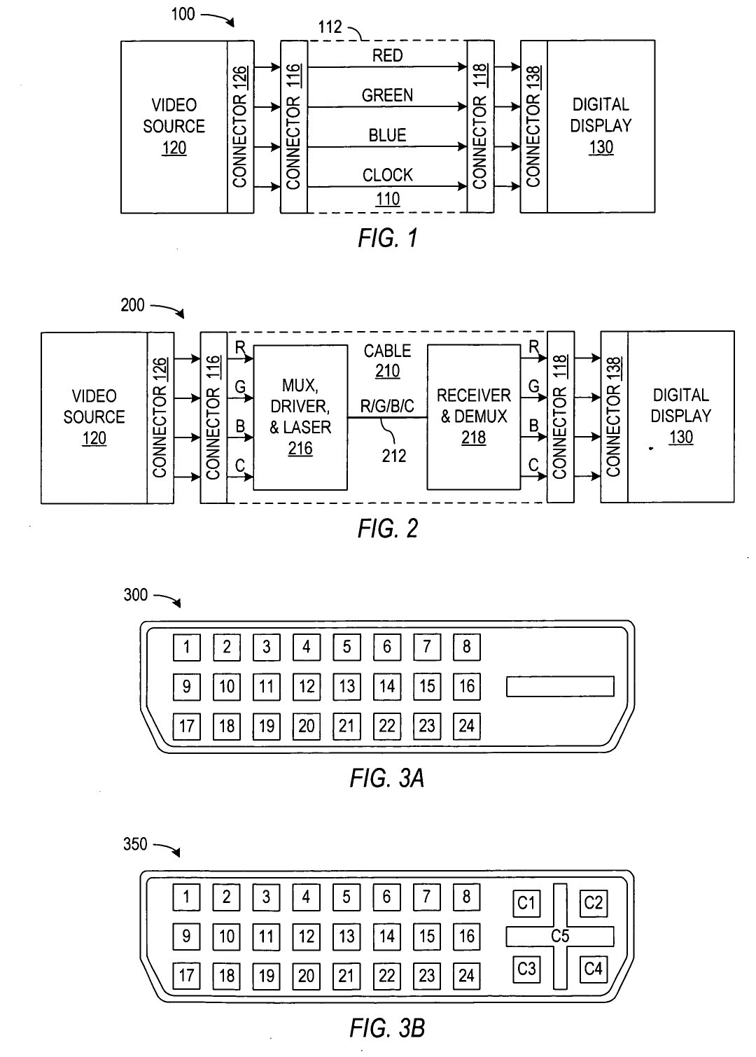

Use of the same reference symbols in different figures indicates similar or identical items.

### DETAILED DESCRIPTIONS

In accordance with an aspect of the invention, a low-power digital graphics connection can employ a single optical fiber, active input circuitry that converts multiple electronic signals from a video source into a single high bandwidth optical signal for transmission on the optical fiber, and active output circuitry that converts the high bandwidth optical signal into separate electronic signals for digital display. The digital graphics connection can comply with an established standard such as DVI but additionally permits long cable lengths without increasing the required transmission power. Additionally, cable diameter and complexity are minimized since a single optical cable carries multiple high frequency pixel data and clock signals.

FIG. 2 illustrates a digital graphics connection 200 in accordance with an embodiment of the invention where a cable 210 containing an optical fiber 212 provides a connection between a video source 120 and a digital display 130. Video source 120 can be any source of digital video including but not limited to a computer, DVD player, or HD-TV tuner. Digital display 130 can be any type of digital visual display including but not limited to a flat panel display, a digital CRT display, a projector, or an HDTV. The following description will concentrate on an exemplary embodiment of the invention in which video source 120 and digital display 130 have connectors and circuitry that complies with the DVI standard. However, principles of the current invention may be applied to other types of digital graphics connections having multiple high bandwidth data channels or clock signals.

In addition to optical fiber 212, the illustrated embodiment of cable 210 includes connectors 116 and 118 and associated active circuits 216 and 218. Active circuits 216 and 218 can be either connected to or incorporated in connectors 116 and 118. As described further below, active circuit 216 includes multiplexing circuits, laser drive circuits, and a laser, and active circuit 218 includes a photodiode and demultiplexing circuits. Connectors 116 and 118 have shapes and pins for connections to respective connectors 126 and 138 on video source 120 and digital display 130.

FIGS. 3A and 3B respectively show the pins of a conventional DVI-D connector 300 and a DVI-I connector 350. DVI-D connector 300 is a digital only connector, and DVI-I connector 350 is an integrated connector for both digital and analog signals. DVI-D connector 300 differs from DVI-I connector 350 in that cross pins C1 to C5 are not used in connector 300 since those pins are associated with analog signals that are not required for digital displays. Table 1 lists the signals associated with each pin shown in FIGS. 3A and 3B.

TABLE 1
DVI-I Pin Assignments

| PIN# | SIGNAL |
|---|---|
| 1 | TMDS DATA 2− |
| 2 | TMDS DATA 2+ |
| 3 | TMDS DATA 2/4 SHIELD |
| 4 | TMDS DATA 4− |
| 5 | TMDS DATA 4+ |
| 6 | DDC CLOCK |
| 7 | DDC DATA |
| 8 | ANALOG VERT. SYNC |
| 9 | TMDS DATA 1− |
| 10 | TMDS DATA 1+ |
| 11 | TMDS DATA 1/3 SHIELD |
| 12 | TMDS DATA 3− |
| 13 | TMDS DATA 3+ |
| 14 | +5 V POWER |
| 15 | GND |
| 16 | HOT PLUG DETECT |
| 17 | TMDS DATA 0− |
| 18 | TMDS DATA 0+ |
| 19 | TMDS DATA 0/5 SHIELD |
| 20 | TMDS DATA 5− |
| 21 | TMDS DATA 5+ |
| 22 | TMDS CLOCK SHIELD |
| 23 | TMDS CLOCK+ |
| 24 | TMDS CLOCK− |
| C1 | ANALOG RED |
| C2 | ANALOG GREEN |
| C3 | ANALOG BLUE |
| C4 | ANALOG HORZ SYNC |
| C5 | ANALOG GROUND |

DVI-D connector 300 or DVI-I connector 350 use six high bandwidth data channels DATA 0 to DATA 5 for pixel data in a dual-link configuration and three of the data channels DATA 0 to Data 2 for pixel data in a single-link configuration. Each of the data channels DATA 0 to DATA 5 transmits pixel data from a source side connector 116 to a display side connector 118 using Transition Minimized Differential Signaling (TMDS) and corresponds to a corresponding one of the differential signal pairs DATA 0−/DATA 0+ to DATA 5−/DATA 5+. Additionally, each pair of data channels 0/5, 1/3, or 2/4 has an associated shield. A high frequency clock signal for synchronization with the data channels is similarly transmitted using TMDS and corresponds to a differential pair of signals CLOCK+ and CLOCK− with an associated shield.

The DVI standard also provides for lower frequency signals for a display data channel (DDC), a DDC clock, and a hot plug detect signal. DVI further provides power supply and ground signals.

In digital graphics connection 200 of FIG. 2, active circuit 216 converts multiple high bandwidth electronic data channels (e.g., three data channels DATA 0 to DATA 2 for a single-link DVI connection or six data channels DATA 0 to DATA 6 for a dual-link DVI connection) and a high frequency clock signal (e.g., the TMDS clock signal) into a bit stream. An optical signal transmitted via optical fiber 212 represents the bit stream. Active circuit 218 uses the optical signal to reconstruct the separate data channels and clock signals.

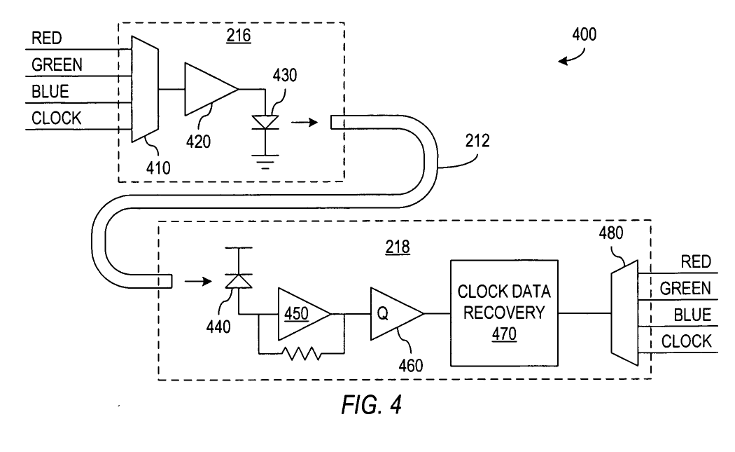

FIG. 4 is block diagram illustrating specific embodiments of active circuits 216 and 218. In the illustrated embodiment, active circuit 216 includes a multiplexing circuit 410, a drive circuit 420, and a laser diode 430 or other light source. Each of the electronic pixel data channel RED, GREEN, and BLUE input to multiplexing circuit 410 represents one or two corresponding data channels DATA 0 to DATA 5 depending on whether a single-link or dual-link DVI connection is desired. Signal CLOCK corresponds to the TMDS clock signal used in a DVI connection and is also input to multiplexer 410. In one specific implementation, multiplexing circuit 410 for a single-link DVI connection receives signals DATA 0+, DATA 1+, DATA 2+, and CLOCK+ of Table 1.

Output selection in multiplexing circuit 410 operates at a frequency higher than the bit rate for pixel data. For example, the clock frequency for multiplexing circuit 410 can be a multiple of (e.g., four times) the bit rate of signal DATA 0+, DATA 1+, or DATA 2+ so that multiplexing circuit 410 outputs a bit stream that sequentially represents the values of signals DATA 0+, DATA 1+, DATA 2+, and CLOCK+. For example, in case of UXGA display size in which the display resolution is 1600×1200 pixels, each pixel data signal DATA 0+, DATA 1+, or DATA 2+ has a bit rate of 1.6 Gbps. If the three (Red, Green, and Blue) signals are combined, the total bit rate for pixel data is 4.8 Gbps (i.e., 1.6 Gbps×3), and the operating frequency of multiplexing circuit 410 should be greater than 4.8 GHz to serially encode all of the pixel data and the clock signal. The clock signal CLOCK+ for the DVI connection generally has a frequency lower than the bit rate of an individual data signal, so that a value of the clock signal may be repeated multiple times for each representation of a bit of pixel data. More generally, multiplexing circuit 410 can use any desired method of serializing pixel data and clock information to create a high frequency bit stream.

Driver circuit 420 drives a laser diode 430, typically a VCSEL or FP laser, to represent the bit stream from multiplexing circuit 410 as a single optical signal. The optical signal can accommodate the entire bandwidth of a DVI connection since the maximum data rate of a dual-link DVI is about 9.6 Gbps, which is easily achieved in optical communications networks. Driver 420 and laser 430 can thus be of types currently used in optical computer networks. Similarly, the optical signal from laser 430 can then be coupled into a conventional optical fiber 212 using well-known optical couplers. For example, driver 420, laser 430, and the associated optical coupler can be implement using a commercially available product such as used in Gigabit Ethernet or 10 Gbit Ethernet products.

Optical fiber 212 carries the optical signal from laser 430 to active circuit 218 on the display side of cable 400. Optical fiber 212 can be a conventional multi-mode or single-mode fiber having shielding or a protective cover such as commonly employed for optical data networks.

Active circuit 218 receives the optical signal from optical fiber 212 and converts the optical signal into parallel data and clock signals as required for DVI connections. To perform this function, the embodiment of active circuit 218 illustrated in FIG. 4 includes a photodiode 440, a trans-impedance amplifier (TIA) 450, a quantizer 460, a clock data recovery circuit 470, and a demultiplexing circuit 480. Photodiode 440 receives the optical signal from optical fiber 212 via an optical coupler (not shown) and generates an electronic signal. TIA 450 and quantizer 460 convert the signal from photodiode 440 into a binary signal having voltage levels corresponding to logical high and low states.

Clock data recovery circuit 470 analyzes the binary signal from quantizer 460 to generate a clock signal. Demultiplexing circuit 480 uses this clock signal, which preferably has the same frequency as used in multiplexing circuit 410 in active circuit 216. Demultiplexing circuit 480 samples the binary signal from quantizer 460 to generate parallel signals RED, GREEN, BLUE, and CLOCK, which respectively represent red pixel data, green pixel data, blue pixel data, and a clock signal. Signals RED, GREEN, BLUE, and CLOCK can then be converted to TMDS signals for output on appropriate pins of a DVI connector.

A single optical fiber 212 as described above can carry all of the high bandwidth signals from video source 120 to digital display 130. Remaining signals implemented in the DVI standard can either be omitted or provided. For example, on the display side, a voltage adapter can provide supply voltage and ground for output via the display-side DVI connector and for use in active circuit 218. (Active circuit 216 can operate using power and ground provided through the DVI connector on the video source side.) The display data signal and the associated DDS clock are generally transmitted back and forth between the video source and the display and can be transmitted on optical cable 212 if an optical transmitter (not shown) is added to the display side and an optical receiver (not shown) is added to the video source side. Alternatively, the display data signal and the associated DDS clock signal are lower frequency signals that can be transmitted across relatively long distances using copper wires (not shown) that are parallel to optical fiber 212. Similarly, the hot plug detect signal can either be omitted, simulated, transmitted via optical fiber 212, or transmitted electronically via an accompanying wire.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. A system for connecting a video source to a digital display, comprising:
a first circuit that encodes digital pixel data from a plurality of parallel electronic signals into a serial optical signal;
a second circuit that decodes the optical signal and recreates the parallel electronic signals; and
an optical fiber coupled to carry the optical signal from the first circuit to a second circuit.

2. The system of claim 1, wherein:
the first circuit is connected to a first DVI connector through which the first circuit receives the parallel electronic signals; and
the second circuit is connected to a second DVI connector through which the second circuit transmits the parallel electronic signals.

3. The system of claim 1, wherein the plurality of parallel electronic signals represent a first data channel, a second data channel, and a third data channel with each of the data channels being encoded using transition minimized differential signaling.

4. The system of claim 3, wherein the plurality of parallel electronic signals further represent a fourth data channel, a fifth data channel, and a sixth data channel with each of the fourth, fifth, and sixth data channels being encoded using transition minimized differential signaling.

5. The system of claim 1, wherein the first circuit further encodes a clock signal into the optical signal, and the second circuit recovers the clock signal from the optical signal.

6. The system of claim 5, wherein each of the electronic signals and the clock signal are encoded using transition minimized differential signaling.

7. The system of claim 1, wherein the first circuit comprises:
a multiplexing circuit having the parallel electronic signals as input signals;
a driver circuit coupled to an output of the multiplexing circuit; and
a light source that under the control of the driver circuit generates the optical signal.

8. The system of claim 1, wherein the second circuit comprises:
a photodiode coupled to receive the optical signal from the optical fiber;
a quantizer connected to generate a binary signal from a signal output from the photon diode;
a clock recovery circuit connected to generate a clock signal from the binary signal; and
a demultiplexing circuit connected to receive the clock signal from the clock recovery circuit and the binary signal from the quantizer, the demultiplexing circuit having a plurality of output ports for recreated parallel electronic signals.

9. The system of claim 1, wherein the first circuit, the second circuit, and the optical fiber are incorporated in a DVI cable.

10. The system of claim 1, wherein the parallel electronic signals comprise:
a first electronic signal representing a first bit stream that indicates values of a first color component of pixels;
a second electronic signal representing a second bit stream that indicates values of a second color component of the pixels; and
a third electronic signal representing a third bit stream that indicates values of a third color component of the pixels.

11. A DVI cable comprising:
a first connector;
a second connector;
a first circuit connected to the first connector, wherein the first circuit operates to convert a plurality of TMDS signals received through the first connector into an optical signal;
a second circuit connected to the second connector, wherein the second circuit operates to recreate the TMDS signals from the optical signal and transmits the TMDS signals via the second connector; and
an optical fiber coupled to convey the optical signal from the first circuit to the second circuit.

12. The DVI cable of claim 11, wherein the TMDS signals comprise a plurality of signals representing parallel channels for pixel data.

13. The DVI cable of claim 12, wherein the TMDS signals further comprise a clock signal.

14. A method for transmitting digital data to a digital display, comprising:
receiving through a first connector of a cable a plurality of parallel electronic signals that digitally represent respective color components of pixels;
using a first circuit integrated into the cable to convert the parallel electronic signals into a serial bit stream;
transmitting an optical signal representing the serial bit stream via an optical fiber that is in the cable and connects the first circuit to a second circuit integrated into the cable;
using a second circuit to recreate the parallel electronic signals from the optical signal; and
transmitting the recreated parallel electronic signals through a second connector of the cable.

15. The method of claim 14, wherein the first connector comprises a DVI connector and the parallel electronic signals comprise TMDS signals representing multiple parallel data channels for pixel data.

16. The method of claim 14, further comprising:
receiving a clock signal through the first connector;
using the first circuit to encode the clock signal into the bit stream; and
using the second circuit to recreate the clock signal from the optical signal.
